(19) United States
(12) Patent Application Publication
(10) Pub. No.: US 2004/0096539 A1
(43) Pub. Date: May 20, 2004

(54) Injection molding method

(76) Inventors: Nicholas John McCaffrey, South Australia (AU); Mark A Wallace, South Australia (AU); David Scott Henderson, South Autralia (AU)

Correspondence Address: BURNS DOANE SWECKER & MATHIS L L P, POST OFFICE BOX 1404, ALEXANDRIA, VA, 22313-1404, US

(21) Appl. No.: 10/472,870

(22) PCT Filed: Mar. 22, 2002
(86) PCT No.: PCT/AU02/00345

(30) Foreign Application Priority Data
Mar. 23, 2001 (AU) PR 3930

(51) Int. Cl. B29C 45/56; B29D 11/00

(52) U.S. Cl. 425/547; 425/552; 425/556; 425/149; 425/808

(57) ABSTRACT

An apparatus for molding an optical lens from a molten thermoplastic resin material using an injection molding machine, and including means for forming a mold cavity defined by a pair of opposed, spaced apart inserts shaped and configured to define opposite faces of said optical lens and having a plurality of overflow wells surrounding the mold cavity means for injecting a predetermined optimum volume of resin material into said mold cavity; means for controllably moving at least one insert relative to the other insert, wherein such relative insert motion is driven by a power cylinder capable of providing a variable compression stroke during molding and is initiated prior to completion of said injection; means for controlling the velocity and/or compressive force of the compression stroke of said power cylinder such that said compression is conducted at a first selected relatively high velocity, thus urging excess resin from said cavity into said overflow wells after which the compression force is varied to a secondary selected level; means for maintaining the secondary selected compressive force on said mold cavity; and means for ejecting the lens.

The present invention relates to a method of molding an optical lens utilising an injection molding system, in particular a high powered and/or highly curved lens or very thin lens.

Numerous methods of molding an article including an optical article are known in the prior art.

Lenses are used for a variety of purposes, for example in optical devices such as microscopes and eye glasses. Over the past few years, the use of thermoplastic material to prepare ophthalmic lenses for such uses as in vision corrective and in prescriptive (Rₓ) spectacle lenses as opposed to traditional glass lenses has increased dramatically because thermoplastic lenses offer several advantages over glass. For example, plastic is lighter than glass and hence spectacles with plastic lens are more comfortable to wear especially since the nominal lens thickness is typically 1.5 to 2.0 mm at the centre of a minus power lens, or at the edge of a plus power lens. Other factors for increased demand for thermoplastic lenses are that these lenses can be made scratch and abrasion resistant, they come in a wide range of fashionable colours, and because the production techniques have improved so that they can now be manufactured at higher rates and in a more automated fashion.

Of the thermoplastic lenses, the use of polycarbonate thermoplastic is becoming very attractive as compared to, for example, lenses made from individual casting and thermoset-peroxide curing allylic resins. Factors favouring polycarbonate thermoplastic lenses include lower density and higher refractive index than cast-thermoset plastic. Hence, thinner lenses in the range of 1.0 to 2.0 mm thickness for a minus power lens can be made. In addition, polycarbonate lenses of the same nominal thickness as thermoset-peroxide cured allylic resins will be of lighter weight, due to lower density, and therefore will impart greater wearer comfort. Furthermore, polycarbonate thermoplastic lenses have far greater impact and breakage resistance than any other optical grade polymeric material.

Heretofore, thermoplastic, injection-molded lenses have been manufactured by injection molding with or without any compression. Injection molding without any compression typically involves the use of a mold cavity having fixed surfaces throughout the molding cycle. Such molding processes employ very long molding cycles, high mold-surface temperatures, higher than average plastication and melt temperatures for that given resin, and slow controlled fill rates followed by very high packing pressures which are held until gate freeze-off is complete.

Early attempts in the prior art to make acrylic or polycarbonate optical articles utilised injection molding with the mold cavity surfaces fixed throughout the molding cycle. This required long cycles, high mold surface temperatures approaching the glass-transition temperature of the plastic, along with high plastication and melt temperatures. However differing cross-sectional thicknesses for example cause non-uniform flow in the lens cavity leading to cosmetic defects and resulting differential shrinkage during part formation and subsequent cooling.

Gate freeze-off in a fixed cavity injection machine presents a problem, given that powered lenses have differing front and back radii of curvature, prescription lenses must therefore have differing cross-sectional thicknesses which in turn leads to non-uniform shrinkage during part formation in the mold cavity and cooling-down which can cause poor optics and/or distortion. In addition, the thickest sections of the lens are subject to slight sink marks or depressions which in turn cause a break in the otherwise uniform radius of curvature of the lens surface. This break results in a localized aberration or deviation in the light bending character of the lens at that area of sink.

One attempt in the prior art to overcome these difficulties is suggested by U.S. Pat. No. 4,828,769 to Galic and Maus (Galic). The Galic patent utilises an injection molding machine in which an opposing pair of mold inserts are initially separated to form a pre-enlarged cavity. A volume of plasticised resin is then injected into the mold cavity and a main clamp force applied to reduce the volume of the mold cavity. The applied main clamp force is maintained until a final lock-up position is reached. The final molded article dimensions being determined by the setable mechanical limits of the machine. However difficulties with the Galic system include an inability to permit uniform shrinkage leading to unwanted stress and optical defects. These are particularly harmful in an optical article exhibiting high curvature and/or low thickness.

It is accordingly an object of the present invention to overcome, or at least alleviate, one or more of the difficulties and deficiencies that relate to the prior art.

Accordingly, in a first aspect of the present invention there is provided a method of molding an optical lens from a molten thermoplastic resin material using an injection molding machine which has a power cylinder for providing a variable compression stroke during molding, said method including the steps of:

providing a mold cavity defined by a pair of opposed, spaced apart inserts shaped and configured to define opposite faces of said optical lens and having a plurality of overflow wells surrounding said mold cavity;

adjusting the distance by which said inserts are spaced from each other;

determining for a particular lens configuration an optimum volume of resin material to be introduced into the mold cavity, and an optimum processing time;

initiating an injection stroke to introduce said optimum volume of resin material into said mold cavity;

once a significant volume of resin material has been introduced into said cavity but prior to the completion of said injection stroke, beginning a compression stroke of said power cylinder, said compression stroke effecting movement of at least one of said inserts towards the other, said compression stroke being conducted at a first relatively high velocity; thus urging said excess resin material from said cavity into said overflow wells;

varying the primary compressive force generated by said compressive stroke to a predetermined secondary level selected to provide improved properties to said optical lens;

maintaining the secondary compressive force on said mold cavity and simultaneously cooling the resin material or allowing the resin material to cool below its solidification temperature, the time taken from the start of the compression stroke until the resin material has cooled being in accordance with said optimum processing time; and

ejecting the molded optical lens from the cavity.

It will be understood that in accordance with the molding method according to the present invention, the molding method exhibits a variable pressure profile which permits internal stresses, and thus optical defects, to be significantly reduced. Similarly, by initiating the compression stroke just prior to the completion of the injection stroke, the propensity of the injection system to produce an unwanted flow line on the surface of the lens is substantially reduced or eliminated.

A relatively high compression velocity is required to avoid the development of high internal stresses, and associated distortion, due to freezing off of the cross-section of the lens during the compression phase. The freezing time of thermoplastics increases rapidly as the thickness is reduced. This causes a reduction in the cross-sectional area available for the molten plastic to flow. High shear stresses can develop in the frozen region, leading to part distortion and cosmetic defects. In extreme cases, if the rapid freezing causes the cross-section to completely freeze, a short shot, defective part will result.

For example, the molding apparatus according to the present invention may exhibit a compression velocity of approximately 0.5 to 30 mm/sec, more preferably approximately 5 to 10 mm/sec.

Similarly, since both the pressure profile and processing time at each stage is precisely controlled, the final dimensions of a range of optical articles, e.g. optical lenses, may be produced within very tight tolerances and exhibiting high optical quality. Preferably, the secondary compressive force is selected to provide a molded optical lens having improved or optimum physical and dimensional tolerances whilst maintaining high optical quality.

In one embodiment, when the molding apparatus utilised in accordance with the method according to the present invention may permit control of the compressive force applied by the compression stroke, it is necessary to generate a relatively high primary compressive force to provide the first relatively high velocity required, e.g. to both squeeze excess material out of the cavity and compress the molten material to compensate for low shrinkage on cooling.

Accordingly, the primary compressive force is subsequently reduced in a controlled manner, preferably in a tapered or step-wise manner, to the required secondary selected level.

In an alternative embodiment, when the molding apparatus utilised permits control of both the velocity and compressive force of the compression stroke independently, it is preferred to maintain the primary compressive force at a relatively low level and to subsequently increase the primary compressive force to the selected secondary level relatively rapidly.

In a preferred embodiment, for example where the optical lens to be molded is a minus (−) lens, the secondary compressive force may be reduced towards the end of the molding cycle.

Accordingly, the molding method may further include, when the optical lens is a minus powered lens, once a substantial portion of the centre thickness of the lens has frozen, reducing the compressive force to a predetermined final level sufficient to maintain contact between the optical inserts and the molded optical lens.

It has been found that, in order to minimise, or at least reduce, the level of compression defects when molding minus lenses it is preferred to reduce the compression force to a lower level, but which is sufficient to ensure contact is maintained. For example, for a −1.50 D optical lens a secondary compressive force of approximately 250 to 400 kN, preferably approximately 275 to 350 kN has been found to be suitable.

The final compressive force may be reduced to approximately 100 to 200 kN, preferably approximately 100 to 150 kN, towards the end of the molding cycle, that is when the central portion of the thickness of the lens has been substantially frozen, e.g. after approximately 10 seconds for a minus powered lens with a final centre thickness of about 1.8 mm.

The optical lenses molded in accordance with the present invention may be lenses of relatively high base curve, for example approximately 9.00 D and above, and of relatively thin wall thickness, e.g. approximately 1.0 mm to approximately 2.0 mm in the centre of a minus powered lens, or at the edge of a plus powered lens.

In a preferred embodiment of the present invention, the molding method may further include a secondary coining or lenticular coining step. The secondary coining step functions to apply compressive force to the edge of the lens, for example to the thick edge of a minus powered lens. This permits greater control of the dimensions of the lens at the periphery thereof, particularly to compensate for shrinkage.

Accordingly, the molding method may further include initiating a supplementary compressive force directed towards the periphery of the lens, coincident with, or subsequent to, initiation of said primary compressive force.

The supplementary compressive force may be provided in any suitable manner. The supplementary compressive force may be applied utilising one or more injectors which inject further thermoplastic resin material from the injection molding machine into the mold cavity. Alternatively a supplementary clamping or hydraulic force may be provided.

It will be understood that the method of molding an optical lens may function as follows. Depending on the curvature of the lens, and wall thickness required, a pair of opposed optical inserts are shaped and configured to define opposite faces of said optical lens. The initial cavity centre thickness is predetermined to give optimum molding conditions and set via the utilisation of thickness adjusting spacers or through setting of a mold position parameter on the molding machine (if available as an option).

The volume of thermoplastic material excluded from the mold cavity may be controlled by the selection of adjustable and interchangeable overflow wells which surround the mold cavity.

A known volume of thermoplastic resin is then injected into the mold cavity by an injection molding machine until a significant volume of thermoplastic resin material has been introduced (e.g. between approximately 50 and 99%). Preferably approximately 70 to 95% of the total volume of the resin material, more preferably approximately 80% of the total volume of resin material, is introduced into the mold cavity prior to the initiation of the compression stroke. This may reduce or avoid the thermoplastic flow front slowing or stopping, which may in turn generate an unwanted flow line defect.

The injection molding machine may be of any suitable type which will permit control of the applied clamp force.

The molding method according to the present invention may function as a cold runner or hot runner system. A hot runner system is preferred for multiple cavity applications, as described below.

Accordingly in a preferred aspect of the present invention the molding method further includes

maintaining the contact surface(s) mold cavity (cavities) at a preselected elevated temperature during the injection stroke.

The mold cavity contact surface(s) may be maintained at a temperature at or above the glass transition temperature, Tg, of the resin material, e.g. for Polycarbonate resin at approximately 140° C. to 170° C., preferably approximately 140° C. to 150° C. Heating may be undertaken utilising any suitable means.

The mold cavity may be provided with a heated circulating fluid or electric heating or a combination thereof. Alternatively, or in addition, a radiant or inductive heating system may be used.

The mold cavity may thereafter be cooled to a temperature at or below the solidification temperature of the resin material, e.g. approximately 80° C. to 140° C., preferably approximately 100° C. to 120° C.

Accordingly, in this aspect of the present invention, the molding method may further include

subsequently cooling the mold cavity to a temperature below the glass transition (Tg) temperature of the resin material.

Depending on the nature of the cooling system, as discussed above, the cooling cycle may be initiated relatively rapidly after the heating cycle has completed. In one embodiment where a remote cooling system is used the cooling and heating cycles may overlap to some degree.

The compression stroke pressure, time and velocity utilised in the molding method may be tightly controlled to ensure good filling and packing of the mold cavity. Preferably, an initially relatively fast compression stroke is selected in order to exclude excess material from the cavity and volumetrically fill the overflow wells, and fast enough to prevent substantial freezing of the lens cross-section. A closing velocity in the range of approximately 0.5 to 30 mm/sec may be used, more preferably approximately 5 to 10 mm/sec.

The compression force of the compression stroke is then varied to a selected secondary level in a controlled fashion in order to avoid possible cavitation and thus the development of internal stress marks and defects. For example as discussed above, where the compression force is reduced, the controlled reduction may be a tapered or step-wise reduction in pressure.

The secondary selected compression force is then maintained for a pre-selected period to hold dimensional tolerances as the whole mold cavity freezes.

Where a minus lens is formed, the compression force may be reduced to a final selected level to avoid lens distortions but the force is sufficient to ensure that the optical inserts remain in contact with the molded lens.

Finally, the molded lenses are ejected from the cavity, supported by the optical inserts, so that stress during ejection is reduced or eliminated.

In a preferred aspect of the present invention, the method may be applied to a multiple mold cavity system. For example the method may include

providing a pair of mold cavities defined by a pair of opposed spaced apart inserts shaped and configured to define opposite faces of a pair of optical lenses, and having a plurality of overflow wells surrounding each mold cavity; the moving parts being linked to a common plate to ensure consistent and coordinated movement thereof.

It will be understood that utilising a pair of mold cavities, linked to a common supporting core activation system, permits more precise control of a pair of optical lenses, thereby ensuring that the inserts move in a concerted and controlled manner, reducing any variation in relative position or force of the inserts.

As stated above, where multiple mold cavities are used, a hot runner system is preferred.

The melt processable material utilised in the preparation of the optical lenses according to the present invention may be of any suitable thermoplastic resin type. An acrylic based material or polycarbonate may be used. Other thermoplastics materials which may be used include Cyclo-olefin copolymers (COC), Polyamide, Polyester, Polystyrene or blends of these polymers. A polycarbonate material is preferred.

The optical lens produced in accordance with the present invention may be an ophthalmic lens adapted for mounting in eyewear, the lens element having a spherical surface with a radius of curvature less than about 35 mm, said lens element being adapted for positioning such that a center of curvature of the lens element is located at the centroid of rotation of the eye, wherein the lens element is sufficiently large to provide a field of view greater than 55° in the temporal direction from the forward line of sight and has a through power in the range of at least approximately +4 D to −6 D.

The ophthalmic lens may be of the type described in International patent applications PCT/AU99/00399 and PCT/AU99/00430, to Applicants, the entire disclosures of which are incorporated herein by reference. The ophthalmic lens may take the form of a standard lens or a semi-finished lens blank.

In a further aspect of the present invention there is provided an apparatus for molding an optical lens from a molten thermoplastic resin material using an injection molding machine, and including

means for forming a mold cavity defined by a pair of opposed, spaced apart inserts shaped and configured to define opposite faces of said optical lens and having a plurality of overflow wells surrounding the mold cavity

means for injecting a predetermined optimum volume of resin material into said mold cavity;

means for controllably moving at least one insert relative to the other insert, wherein such relative insert motion is driven by a power cylinder capable of providing a variable compression stroke during molding and is initiated prior to completion of said injection;

means for controlling the velocity and/or compressive force of the compression stroke of said power cylinder such that said compression is conducted at a first selected relatively high velocity, thus urging excess resin from said cavity into said overflow wells after which the compression force is varied to a secondary selected level;

means for maintaining the secondary selected compressive force on said mold cavity; and

means for ejecting the lens.

It will be understood that the apparatus according to the present invention may be utilised in combination with any standard injection molding machine.

The apparatus according to this aspect of the present invention permits the generation of a variable pressure profile which permits internal stresses, and thus optical defects, to be significantly reduced. Similarly, by initiating the compression stroke just prior to the completion of the injection stroke, the propensity of the injection system to produce an unwanted flow line on the surface of the lens is substantially reduced or eliminated.

In a preferred embodiment of the present invention, the molding apparatus may include means for controlling both the velocity and compressive force of the compression stroke.

In this embodiment, the velocity of the compression stroke may be controlled independently of compressive force. Thus the first relative high velocity preferred for the initial compression stroke may be achieved with a relatively low applied primary compressive force. The compressive force may subsequently be increased relatively rapidly to the selected secondary level. For example, as discussed above, the molding apparatus according to the present invention may exhibit a compression velocity of approximately 0.5 to 30 mm/sec, more preferably approximately 5 to 10 mm/sec.

In an alternative embodiment, the control means may permit control of the velocity of the compression stroke via control of compressive force. As discussed above, it is necessary to generate a relatively high primary compressive force to provide the first relatively high velocity required. The compressive force may subsequently be reduced to the selected secondary level in a controlled manner, preferably in a tapered or step-wise manner.

In a further preferred embodiment the control means may permit reduction of the secondary selected compressive force to a final selected compressive force.

In a still further preferred embodiment of the present invention, the first insert forming the mold cavity may be mounted on a fixed mold plate and the second opposed insert is mounted on a movable mold plate.

The fixed and movable mold plates may be mounted between a pair of platens attached together utilising a tie bar.

In a further preferred embodiment each overflow well of the molding apparatus may include means for controlling the amount of overflow therein. The overflow control means may include a plurality of insertable overflow well ejector pins.

In a preferred embodiment of the present invention, the molding apparatus may further include means for applying a supplementary compressive force directed towards the periphery of the lens coincident with or subsequent to, initiation of said primary compressive force.

This permits a secondary coining or lenticular coining step to be conducted. As stated above, this permits greater control of the dimensions of the lens at the periphery thereof, particularly to compensate for shrinkage.

Such supplementary means may include one or more injectors capable of injecting further thermoplastic resin material into the mold cavity.

Alternatively or in addition such supplementary means may include means for applying the supplementary compressive force includes a means for applying a supplementary clamping or hydraulic force.

As discussed above, the molding apparatus may be run as a hot runner or cold runner system. A hot runner system may be used where multiple mold cavities are included.

In a further embodiment of the present invention, the molding apparatus may further include means for heating the contact surface(s) of the mold cavity.

The means for heating the mold cavity contact surface(s) may include means for circulating heated fluid or an electric heating system or a combination thereof. Alternatively, or in addition, the heating means may include a radiant or induction heating system.

The molding apparatus according to this aspect may further include means for cooling the contact surface(s) of mold cavity.

The cooling means may include means for circulating a cooling fluid or other refrigerant means.

In a further preferred embodiment, the means for forming the mold cavity may further include means for setting the distance between said spaced apart inserts. The distance setting means may include one or more thickness adjusting spacers or may include a programmable means for setting of a mold position parameter on the molding apparatus.

The molding apparatus according to the present invention may further include

means for forming a pair of mold cavities defined by a pair of opposed spaced apart inserts shaped and configured to define opposite faces of a pair of optical lenses, and having a plurality of overflow wells surrounding each mold cavity;

the moving parts being linked to a common plate to ensure consistent and coordinated movement thereof.

As stated above the provision of a pair of mold cavities, linked to a common supporting core activation system, permits more precise control of a pair of optical lenses, thereby ensuring that the inserts move in a concerted and controlled manner, reducing any variation in relative position or force of the inserts.

The present invention will now be more fully described with reference to the accompanying drawings and examples. It should be understood, however, that the description following is illustrative only and should not be taken in any way as a restriction on the generality of the invention as described above.

In the figures:

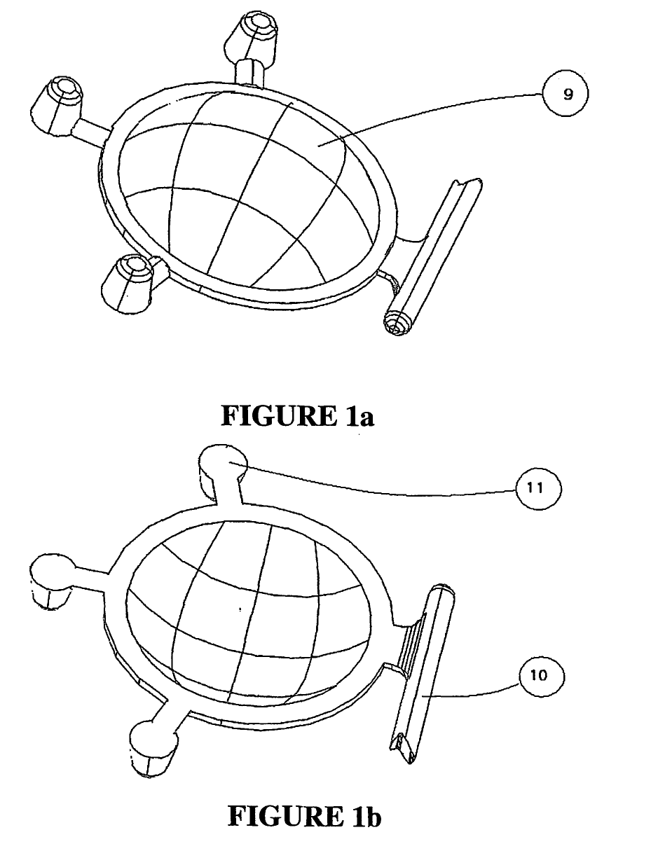

FIG. 1 illustrates an optical lens molded utilising the molding method according to the present invention.

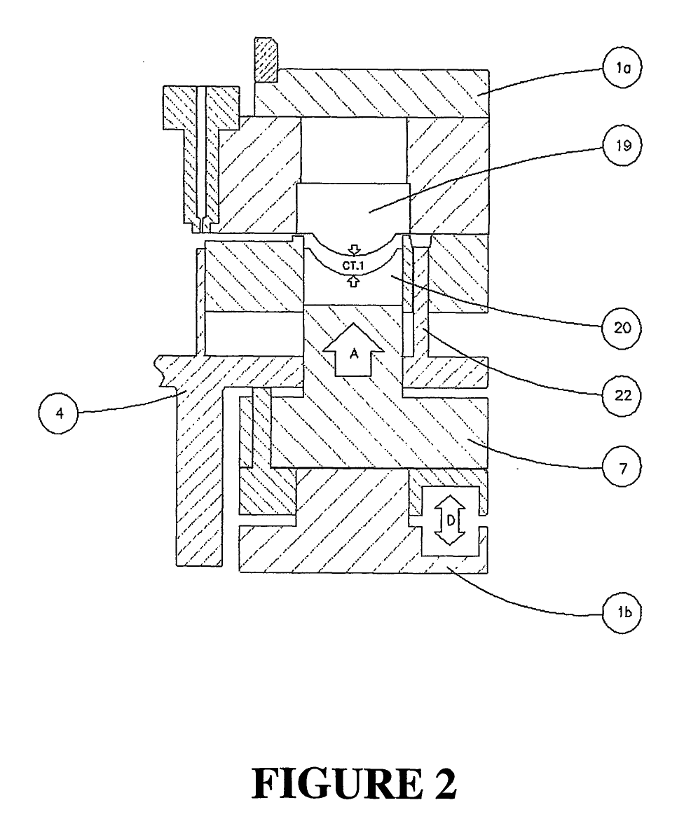

FIG. 2 illustrates the injection molding and compression system according to the present invention with the mold closed and tension plate pre-loaded.

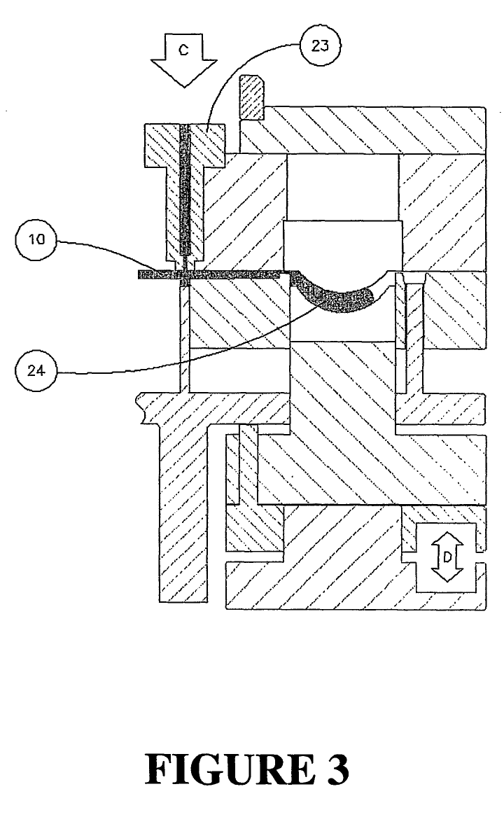

FIG. 3 illustrates the injection molding and compression system according to FIG. 2, after the injection stroke has been initiated and the mold cavities part filled.

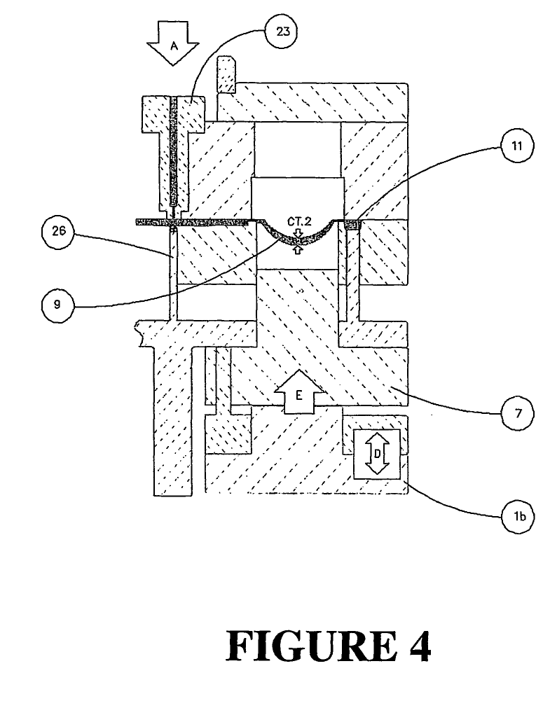

FIG. 4 illustrates the injection molding system and compression system according to the present invention after thermoplastic material has been expelled into the overflow wells and maximum compression force supplied.

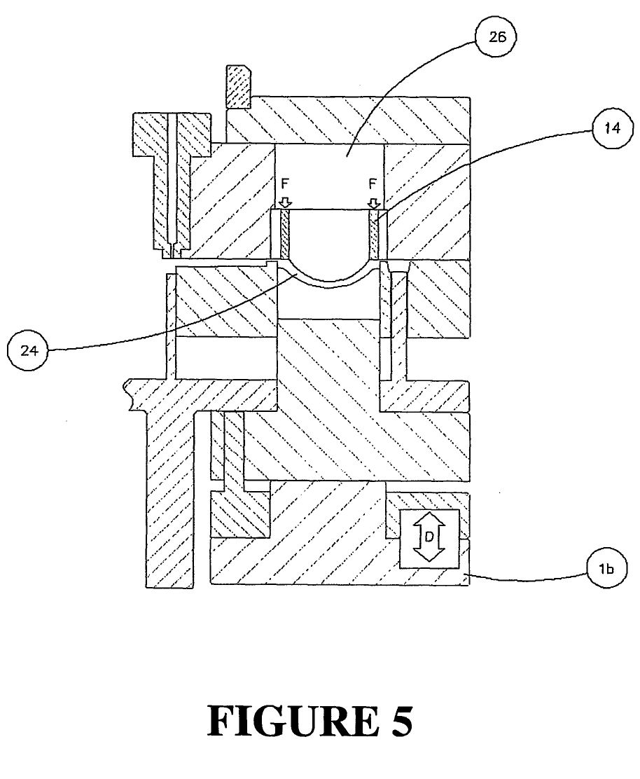

FIG. 5 illustrates an alternative embodiment of the injection molding and compression system according to the present invention. In this embodiment, the system may be characterised as providing lenticular coining with pre-exclusion and gate shutoff.

The mold is closed and the edge coining system moved forward. The coining system may be activated through direct hydraulic pressure, use of a tapered shoe with a sliding wedge, toggle activated, or other means.

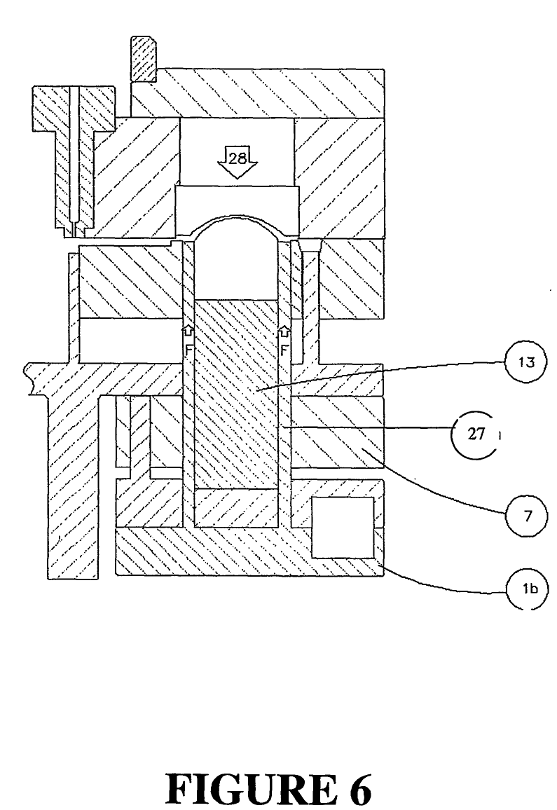

FIG. 6 illustrates an alternative embodiment of the injection mold and compression system according to the present invention, again providing lenticular coining with pre-exclusion, this embodiment exhibiting a reversed coining configuration which may be simpler to implement within the same tool as previously described.

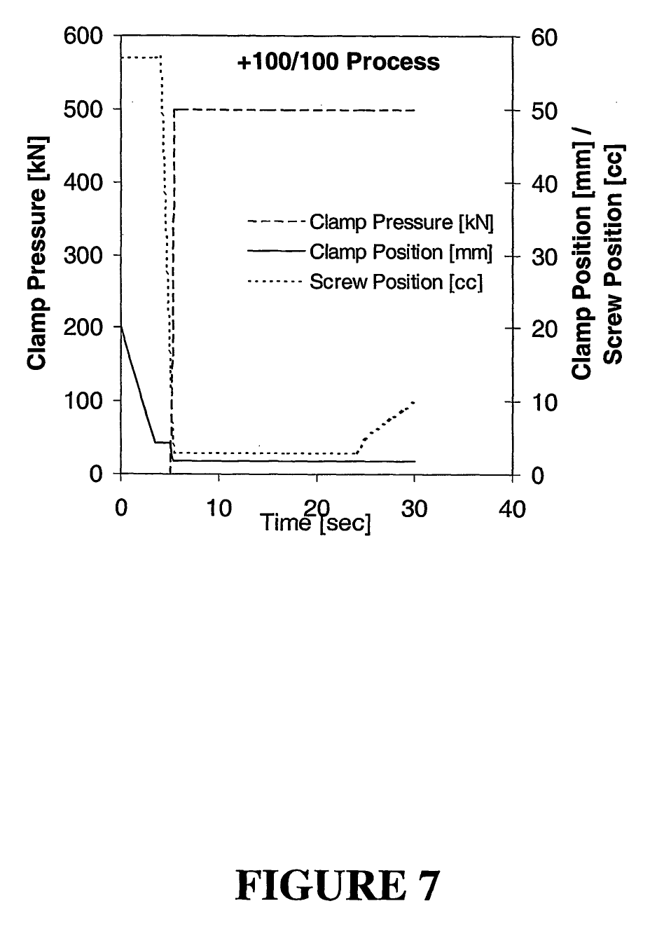

FIG. 7 is a graph showing variations of centre thickness, clamp position and screw position with time for a molding cycle for the manufacture of a +1.00/1.00 lens according to the present invention.

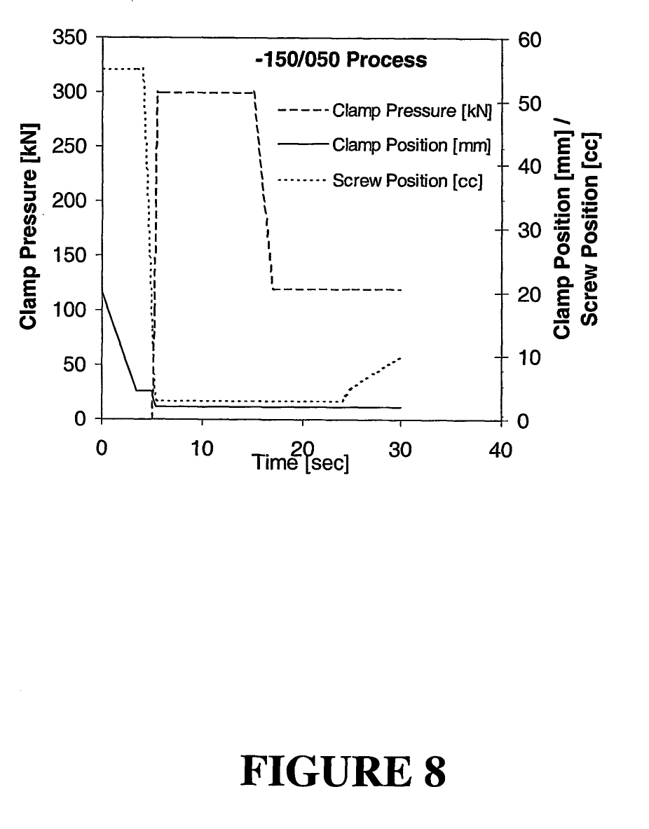

FIG. 8 is a graph showing variations of centre thickness, clamp position and screw position with time for a molding cycle for the manufacture of a −1.50/0.50 lens according to the present invention.

In more detail, FIG. 1 illustrates a pair of lenses after ejection from the injection molding system of FIG. 1. FIG. 1a shows the view from the front of the lens. FIG. 1b shows the same lens when viewed from behind. The lens 9 is attached via a solidified injection runner 10 and each bear overflow well residues 11.

As best illustrated in FIGS. 2 to 4, the injection molding system is initially open with the ejector plate 4 and coining system 7 returned. Depending on the thickness and curvature of the lenses to be molded, appropriate upper mold inserts and back mold support collars 19 are mounted in position, together with corresponding lower mold inserts and support collars 20. The lower mold section located on platen 1b is then closed in direction of arrow A such that the initial lens blank thickness CT1 is defined by the adjustable height of lower mold inserts and supports, 20 and upper mold inserts and supports 19 or through setting of an adjustable mold position parameter on the molding machine controller, if available. The amount of overflow in the overflow wells is set via selection of appropriate insertable overflow well ejector pin 22.

As best illustrated in FIG. 3, molten thermoplastic material is then injected from an injection molding machine (not shown) through an injection conduit 23 to define an injection line 10 and ultimately filling the mold cavities 24. The direction of movement of the molten thermoplastic material is shown by arrow C.

As best illustrated in FIG. 4, injection continues until e.g. approximately 80% of the preselected amount of molten thermoplastic material is introduced into the pre-enlarged cavity. The coining system 7 is then activated to squeeze excess material out of the mold cavities and into the overflow wells 11. The direction of movement of the coining system is shown by arrow E against spring D. The compression system exhibits a relatively fast initial compression stroke to a) squeeze excess material out of the cavity, b) prevent substantial freezing of the lens cross-section during compression leading to development of internal stresses and cosmetic defects, and c) compress the molten material to compensate for lens shrinkage on cooling.

The high compression pressure is then applied and maintained until the molten material in the mold cavities begins to freeze off.

The compression pressure is gradually tapered off as the material in the mold cavity freezes to avoid over compressing the solidified lens which in turn may cause stress marks.

The lower compression pressure is maintained to ensure the precise shape of the solidified lens is retained as the lens material cools to ejection temperature. The coining system is then returned. The upper mold section is then opened. The ejector plate is activated which subsequently activates well ejectors 25 and runner ejector 26. The molded lens 9 may then be removed.

As illustrated in FIGS. 5 and 6, the molding apparatus according to the present invention may include means for generating a supplementary compressive force to achieve secondary lenticular coining.

In one lenticular coining embodiment illustrated in FIG. 5, the mold cavity 24 is initially partially open. Closure of the mold cavity is actuated by coining system 7 to squeeze excess material out of the mold cavity and into the overflow wells. Secondary coining is then actuated by a mechanism shown as 26, which may include horizontal movement of a slide cam, a toggle arrangement, use of a hydraulic fluid or other means.

In the embodiment of FIG. 5, arrows F indicate the direction of motion of an annular coining ring 14 which applies an annular compressive force to the thick edge of for example a high minus optical lens 24.

In an alternative embodiment illustrated in FIG. 6, the central lenticular coining arrangement is such that the optical inserts are reversed. Actuation of the primary compressive or coining stop is via mechanism 28. Secondary coining is achieved via motion of the coining cylinder 27 in the direction shown by arrows F via motion of platen 1b.

### EXAMPLES

### Example 1

In this example, a Polycarbonate resin (commercial high viscosity ophthalmic grade) is used to form an optical lens. Upper and lower mold inserts 19 and 20 are shaped to form a +1.00/1.00 lens, that is a plus lens having +1.00 D sphere power and 1.00 D cylinder power.

The molding cycle is illustrated with reference to Table 1 and FIG. 7.

At the time 0 sec the mold is fully open (>100 mm) and moves to a first position where the optical lens inserts are separated by 4.3 mm. Injection of Polycarbonate resin is then initiated at 4 seconds total elapsed time from an injection molding machine through injection conduit 23. Initially 57 cc of polycarbonate resin is in the injection unit.

When injection volume has been injected, approximately 75% of the total, after 5 secs, the compression stroke is initiated (high velocity stage). Centre thickness is then reduced to 2.2 mm in 0.2 seconds.

Clamp force (pressure) is maintained relatively low (approximately 200 kN) during the high velocity stage.

The second, high pressure stage is then initiated after 5.4 seconds total elapsed time, with centre thickness reduced to approximately 1.8 mm, clamp force (pressure) rising to approximately 500 kN.

High clamp force is maintained until the centre of the ophthalmic lens is substantially solidified, e.g. after approximately 120 seconds total elapsed time. The finished lens is then ejected.

TABLE 1

| | Clamp Position | Screw Position | Clamp Pressure |
|---|---|---|---|
| Time [sec] | [mm] | [cc] | [kN] |
| 2 | 20 | 57 | 0 |
| 3.5 | 4.3 | 57 | 0 |
| 4 | 4.3 | 57 | 0 |
| 5 | 4.3 | 14 | 0 |
| 5.2 | 2.2 | 5 | 200 |
| 5.4 | 1.8 | 3 | 500 |
| 6 | 1.8 | 3 | 500 |
| 15 | 1.8 | 3 | 500 |
| 17 | 1.8 | 3 | 500 |
| 24 | 1.8 | 3 | 500 |
| 25 | 1.8 | 5 | 500 |
| 30 | 1.8 | 10 | 500 |

### Example 2

In this example, the process of molding a lens described in Example 1 is repeated for a −1.50/0.50 lens, that is a minus lens having −1.50 D sphere power and 0.50 D cylinder power.

The molding cycle is illustrated with reference to Table 2 and FIG. 8.

In this example, at time 0 sec, the mold is fully open (>100 mm) and moves to a first position where the optical lens inserts the separated by 4.5 mm.

Injection of polycarbonate resin is then initiated at 4 seconds total elapsed time from an injection molding machine through injection conduit 23. Initially 55 cc of polycarbonate resin is in the injection unit.

When approximately 75% of the total injection volume has been injected, after 5 seconds, the compression stroke is initiated.

Centre thickness is then reduced to 3 mm in 0.2 secs (high velocity stage). Clamp pressure is kept relatively low at approximately 100 kN during the high velocity stage.

The second, high compressive pressure stage is then initiated after 5.4 seconds total elapsed time, with centre thickness reduced to 1.8 mm. Clamp force (pressure) is increased to 300 kN.

High clamp force is maintained for 15 seconds total elapsed time after which clamp force is reduced to 120 kN and maintained for approximately 120 seconds total elapsed time. The reduced clamp force eliminates the possibility of distortion defects with minus powered lenses, whilst maintaining contact between the optical inserts and the partially frozen molded lens.

The finished lens is then ejected.

TABLE 2

| | Clamp Position | Screw Position | Clamp Pressure |
|---|---|---|---|
| Time [sec] | [mm] | [cc] | [kN] |
| 2 | 20 | 55 | 0 |
| 3.5 | 4.5 | 55 | 0 |
| 4 | 4.5 | 55 | 0 |
| 5 | 4.5 | 14 | 0 |
| 5.2 | 3 | 5 | 100 |
| 5.4 | 2 | 3 | 300 |
| 6 | 2 | 3 | 300 |
| 15 | 2 | 3 | 300 |
| 17 | 2 | 3 | 120 |
| 24 | 2 | 3 | 120 |
| 25 | 2 | 5 | 120 |
| 30 | 2 | 10 | 120 |

It will be understood that the invention disclosed and defined in this specification extends to all alternative combinations of one or multiple sets of the individual features mentioned or evident from the text or drawings. All of these different combinations constitute various alternative aspects of the invention.

It will also be understood that the term “comprises” (or its grammatical variants as used in this specification is equivalent to the term “includes” and should not be taken as excluding the presence of other elements or features.

1. A method of molding an optical lens from a molten thermoplastic resin material using an injection molding machine which has a power cylinder for providing a variable compression stroke during molding, said method including the steps of:
providing a mold cavity defined by a pair of opposed, spaced apart inserts shaped and configured to define opposite faces of said optical lens and having a plurality of overflow wells surrounding said mold cavity;
adjusting the distance by which said inserts are spaced from each other;
determining for a particular lens configuration, an optimum volume of resin material to be introduced into the mold cavity, and an optimum processing time;
initiating an injection stroke to introduce said optimum volume of resin material into said mold cavity;
once a significant volume of resin material has been introduced into said cavity but prior to the completion of said injection stroke, beginning a compression stroke of said power cylinder, said compression stroke effecting movement of at least one of said inserts towards the other, said compression stroke being conducted at a first relatively high velocity, thus urging said excess resin material from said cavity into said overflow wells;
varying the primary compressive force generated by said compressive stroke to a predetermined secondary level selected to provide improved properties to said optical lens;
maintaining the secondary compressive force on said mold cavity and simultaneously cooling the resin material, or allowing the resin material to cool, below its solidification temperature, the time taken from the start of the compression stroke until the resin material has cooled being in accordance with said optimum processing time; and
ejecting the molded optical lens from the cavity.

2. A method according to claim 1, wherein approximately 70 to 95% of the total volume of the resin material is introduced into the mold cavity prior to the initiation of the compression stroke.

3. A method according to claim 2, wherein the first relatively high velocity is sufficient to prevent substantial freezing of the cross-section of the molded optical lens.

4. A method according to claim 3, wherein the compression velocity is approximately 0.5 to 30 mm/sec.

5. A method according to claim 4, wherein the secondary compressive force is selected to provide a molded optical lens having improved physical and dimensional tolerances whilst maintaining high optical quality.

6. A method according to claim 5, wherein the compressive stroke generates a relatively high primary compressive force to provide the required first relatively high velocity, the compressive force being subsequently reduced at a controlled rate of reduction to the secondary selected level.

7. A method according to claim 5, wherein when the velocity of the compression stroke is directly controlled, the primary compressive force is maintained at a relatively low level; the compressive force being subsequently increased to the secondary selected level.

8. A method according to claim 1, wherein the method further includes
initiating a secondary coining or lenticular coining step; the coining step functioning to apply compressive force to the edge of the optical lens.

9. A method according to claim 8, wherein the coining step includes initiating a supplementary compressive force directed towards the periphery of the lens coincident with, or subsequent to, initiation of said primary compressive force.

10. A method according to claim 9, wherein the supplementary compressive force is applied utilising one or more injectors, which inject further thermoplastic resin material from the injection molding machine into the mold cavity.

11. A method according to claim 9, wherein the supplementary compressive force is applied utilising a supplementary clamping or hydraulic force.

12. A method according to claim 1, wherein the method further includes
maintaining the contact surface of the mold cavity at a preselected elevated temperature during the injection stroke.

13. A method according to claim 12 wherein the mold cavity contact surface is maintained at or above the glass transition temperature Tg of the resin material.

14. A method according to claim 12, which method further includes
cooling the contact surface of the molding cavity to a temperature below the solidification temperature of the resin material.

15. A method according to claim 1, wherein the method further includes, when the optical lens is a minus powered lens, once a substantial portion of the centre thickness of the lens has frozen, reducing the compressive force to a predetermined final level sufficient to maintain contact between the optical inserts and the molded optical lens.

16. A method according to claim 15, wherein, for a minus powered optical lens, the secondary compressive force is approximately 250 to 400 kN and the final compressive force is reduced to approximately 100 to 200 kN.

17. A method according to claim 1, wherein the opposed spaced apart inserts are shaped and configured to define opposite faces of an optical lens having a relatively high base curve and of relatively thin wall thickness.

18. A method according to claim 17, wherein the lens has a base curve of approximately 9.00 D or above, and a thickness of approximately 1.0 mm to approximately 2.0 mm at the centre of a minus powered lens or at the edge of a plus powered lens.

19. A method according to claim 1, wherein the distance between said spaced apart inserts defines the initial cavity centre thickness which is predetermined to give optimum molding conditions.

20. A method according to claim 19, wherein the distance between said spaced apart inserts is set utilising one or more thickness adjusting spacers.

21. A method according to claim 20, wherein the distance between said spaced apart inserts is set utilising a setting for a mold position parameter on the injection molding machine.

22. A method according to claim 1, wherein the method further includes
providing a pair of mold cavities defined by a pair of opposed spaced apart inserts shaped and configured to define opposite faces of a pair of optical lenses, and having a plurality of overflow wells surrounding each mold cavity;
the moving parts being linked to a common plate to ensure consistent and coordinated movement thereof.

23. An apparatus for molding an optical lens from a molten thermoplastic resin material using an injection molding machine, and including
means for forming a mold cavity defined by a pair of opposed, spaced apart inserts shaped and configured to define opposite faces of said optical lens and having a plurality of overflow wells surrounding the mold cavity
means for injecting a predetermined optimum volume of resin material into said mold cavity;
means for controllably moving at least one insert relative to the other insert, wherein such relative insert motion is driven by a power cylinder capable of providing a variable compression stroke during molding and is initiated prior to completion of said injection;
means for controlling the velocity and/or compressive force of the compression stroke of said power cylinder such that said compression is conducted at a first selected relatively high velocity, thus urging excess resin from said cavity into said overflow wells after which the compression force is varied to a secondary selected level;
means for maintaining the secondary selected compressive force on said mold cavity; and
means for ejecting the lens.

24. An apparatus according to claim 23, wherein the control means permits control of both the velocity and compressive force of the compression stroke.

25. An apparatus according to claim 24, wherein the control means permits reduction of the secondary selected compressive force to a final selected compressive force.

26. An apparatus according to claim 23, wherein each overflow well includes means for controlling the amount of overflow therein.

27. An apparatus according to claim 26, wherein the overflow control means includes a plurality of insertable overflow well ejector pins.

28. An apparatus according to claim 23, wherein the first insert is mounted on a fixed mold plate and the second opposed insert is mounted on a movable mold plate.

29. An apparatus according to claim 23 wherein the apparatus further includes
including means for applying a supplementary compressive force directed towards the periphery of the lens coincident with or subsequent to, initiation of said primary compressive force.

30. An apparatus according to claim 29, wherein the means for applying the supplementary compressive force includes one or more injectors capable of injecting further thermoplastic resin material into the mold cavity.

31. An apparatus according to claim 29, wherein the means for applying the supplementary compressive force includes a means for applying a supplementary clamping or hydraulic force.

32. An apparatus according to claim 31, wherein the means for applying a supplementary clamping or hydraulic force includes a secondary or lenticular coining arrangement.

33. An apparatus according to claim 32, wherein the secondary lenticular coining arrangement includes an actuating means selected from a slide cam, hydraulic fluid or toggle arrangement.

34. An apparatus according to claim 23, wherein the means for forming the mold cavity further includes means for setting the distance between said spaced apart inserts.

35. An apparatus according to claim 34, wherein the distance setting means includes one or more thickness adjusting spacers.

36. An apparatus according to claim 23 wherein the apparatus further includes
means for heating the contact surface of the mold cavity.

37. An apparatus according to claim 36 wherein the heating means includes means for circulating heated fluid, or an electric heating system, or a combination thereof.

38. An apparatus according to claim 23, wherein the apparatus further includes
means for cooling the contact surface of the mold cavity.

39. An apparatus according to claim 38, wherein the cooling means includes means for circulating a cooling fluid or other refrigerant means.

40. An apparatus according to claim 23, wherein the apparatus further includes
means for forming a pair of mold cavities defined by a pair of opposed spaced apart inserts shaped and configured to define opposite faces of a pair of optical lenses, and having a plurality of overflow wells surrounding each mold cavity;
the moving parts being linked to a common plate to ensure consistent and coordinated movement thereof.

41. An optical lens whenever produced using a method according to claim 1.

42. An optical lens according to claim 41, wherein the lens exhibits a base curve of 9.00 D or above and a thickness of approximately 1.0 mm to 2.0 mm at the centre of a minus powered lens or at the edge of a plus powered lens.
